(19) United States
(12) Patent Application Publication
(10) Pub. No.: US 2016/0224622 A1
(43) Pub. Date: Aug. 4, 2016

(54) METHOD FOR DETECTING THE SIMILARITY OF THE PATENT DOCUMENTS ON THE BASIS OF NEW KERNEL FUNCTION LUKE KERNEL

(71) Applicants: JIANGSU UNIVERSITY, Jiangsu (CN); NANJING FENGGONG AGRICULTURAL SCIENCE & TECHNOLOGY CO., LTD., Nanjing, Jiangsu (CN)

(72) Inventor: Xiuhong WANG, Jiangsu (CN)

(73) Assignees: JiangSu University, Jiangsu (CN); NANJING FENGGONG AGRICULTURAL SCIENCE & TECHNOLOGY CO., LTD., Jiangsu (CN)

(21) Appl. No.: 14/915,643

(22) PCT Filed: Sep. 2, 2014
(86) PCT No.: PCT/CN2014/085732

§ 371 Date: Mar. 1, 2016

(30) Foreign Application Priority Data
Sep. 5, 2013 (CN) 201310400244.4

(51) Int. Cl. G06F 17/30

(52) U.S. Cl. CPC G06F 17/30424

(57) ABSTRACT

A method for detecting the similarity of the patent documents based on a new kernel function Luke kernel comprises: dividing a patent document into five elements, i.e. patent title, abstract, claims, description, and main classification, constructing a new kernel function Luke kernel, calculating the similarity of the first four elements of two patent documents by using the Luke kernel, calculating the similarity between the main classifications of the two patent documents by means of character string matching, and then performing a weighted summation of the similarities of the five elements of the two patent documents to obtain an overall similarity of the patent documents. The method further improves the precision and recall in detecting the similarity of the patent documents, and can be applied to detection for the similarity of the patent documents.

### BACKGROUND OF THE INVENTION

1. Field of the Invention

The present invention relates to information retrieval, and more particularly to calculation of the similarity of texts of patent documents.

2. Description of Related Art

The similarity of patents refers to the similarity in technical contents between the patents. The existing calculation methods are generally divided into two categories: the first one being based on analysis of patent citations, the second one being based on analysis of patent contents. The studies to analyze the similarity between documents using the citation analysis method have been known for a long time. In detection of the similarity of patents, Stuart has measured the technical similarity of 10 semiconductor companies from Japan using co-citation relationships of the patents. Lai has measured the similarity of patents using the co-citation analysis method. McGill and Mowery et al. have measured the similarity of patents between companies in the Patent Union in the cross-citation rate in analyzing the relationships between the companies. There are many drawbacks in measuring the similarity of patents using the citation analysis method: the similarity between patents having the citation relationships can be only embodied, and the similarity relationships between all patents that are actually correlated with each other cannot be indicated. For example, most of Chinese patents have no citations, so calculation of the similarity between such patent documents cannot be perfectly achieved by the citation analysis method. Current studies to analyze the similarity in contents between patents based on patent contents mainly are mainly as follows: Bergmann, Moehrle et al. proposed patent semantic analysis; Gerken proposed measurement of novelty in patents based on semantic patent analysis in 2012. Cascini proposed the invention functional tree method, wherein the similarity of patents is determined by comparing the components in the tree and the functions and hierarchical relationships thereof, which reflects the similarity in concept of the patents and not the similarity in contents of the patents. Magerman et al. verified the accuracy and possibility of the text mining technology in measuring the similarity of patents, Yoon et al. performed pretreatment on patent documents by the text mining technology, constructed vectors of keywords in the patents, and calculated similarity of the patents using the conventional method by calculating Euclidian distances between the vectors, wherein the precision and recall in detecting the similarity remain to be further improved. Chen Jixi et al. constructed the patent tree model and its nodes according to the characteristics of patent documents, and calculated the similarity base on the existing vector space models, wherein a weighted similarity of patent title and abstract information is used as the basis of classification. Peng Jidong and Tan Zongying proposed a text-based mining technique, wherein a weighted similarity of four text elements including patent title, abstract, claims, and description is used as a measure of the similarity between patents.^{[1]} Kim et al. proposed that the contribution of a given node on the node similarity matrix is calculated using the singular-value method in 2012, thereby detecting influential patents. Moehrle proposed a text-based method for measuring the similarity of patents based on design decisions and results thereof in 2012. Compared to the citation analysis method, the content-based method for calculating the similarity of patents has the advantages of more accuracy and comprehensibility. In most of the existing studies, the similarity between the same class or within the same feature is calculated by analyzing the characteristics of patent documents using the existing calculation methods based on vector space models or text mining techniques; the S_Wang kernel^{[2]} proposed by the group (Patent No. ZL201210105942.7) has a better performance in fusion of results from distributed information retrieval.

The most essential problem in detecting the similarity of patent documents is to calculate the similarity between two patent documents. The mathematical models used to calculate the similarity of patent documents in the prior art often adapt the conventional mathematical models for vector similarity calculation, which are lack of specificity; only title, abstract, claims, and description are considered in terms of structural elements of the patent documents and an important role of the International Patent Classification (IPC) in calculating the similarity of the patent documents is neglected; both precision and recall of the existing methods in calculating the similarity of the patent documents remain to be further improved.

### [1] Peng Jidong, Tan Zongying, Text Mining-Based Method For Measuring The Similarity Of Patents And Application Thereof, Information Studies: Theory & Application, 2012 (12): 114-118.

[2] Wang Xiuhong, Method For Detecting Similarity Of Documents Based On Kernel Function, Patent No. ZL201210105942.7.

### SUMMARY OF THE INVENTION

An object of the present invention is to provide a method for detecting the similarity of patent documents based on a new kernel function Luke kernel, further improving the precision and recall in calculating the similarity between the patents.

In order to solve the above technical problem, the present invention has constructed a new kernel function suitable for calculation of the similarity of the patent documents, with the consideration of the important role of IPC in calculating the similarity of the patent documents. A specific technical solution is as follows:
A method for detecting the similarity of patent documents based on a new kernel function Luke kernel, comprising:

step 1, representing the texts of two patent documents to be compared DX and DZ as vectors x and z;

step 2, structural representation of the patent documents, by dividing the patent documents into five elements including patent title, abstract, claims, description, and main classification, i.e. IPC main classification, and representing the first four elements of the two patent documents to be compared DX and DZ as vectors x₁, x₂, x₃, x₄, and z₁, z₂, z₃, z₄ according to the step 1 respectively;

step 3, constructing a new kernel function k(x, z) suitable for calculation of the similarity of the patent documents, and it is proved by the theory whether the function k(x, z) can be regarded as a kernel function for calculation of the similarity;

step 4, calculating the similarity Sⱼ between the respective first four elements of the two patent documents to be compared DX and DZ by using the kernel function k(x, z): Sⱼ=k(xⱼ, zⱼ), wherein j=1, 2, 3, 4;

then calculating the similarity S₅ between the main classifications of the two patent documents to be compared DX and DZ directly by means of character string matching, specifically by comparing the main classifications for section, class, subclass, main group, and subgroup from front to back, wherein if the main classifications of the two patents are identical, namely, section to subgroup numbers are the same, then S₅=1; if subgroup numbers are different but main group numbers are the same, then S₅=0.75; if main group numbers are different but subclass numbers are the same, then S₅=0.5; if subclass numbers are different but class numbers are the same, then S₅=0.25; if class numbers are different but section numbers are the same, then S₅=0.1; and if all numbers are different, then S₅=0;

and finally performing a weighted summation to obtain the similarity S of the two patent documents to be compared DX and DZ:

$$S = {\sum }_{j = 1}^{5} {ζ}_{j} {S}_{j} ;$$

wherein

$${\sum }_{j = 1}^{5} {ζ}_{j} = 1 , 0 \leq {ζ}_{j} \leq 1 , j = 1 , 2 , … , 5.$$

The new kernel function k(x, z) is in the form of k(x, z)=log₂^{(x}^{^{T}}^{z+1)}.

The theoretical demonstration that the new kernel function can be regarded as a kernel function is as follows:

let X is a compact set on Rⁿ, and k(x, z) is a continuous real-valued symmetric function on X×X, then:

$${\int \int }_{X \times X} k ( x , z ) f ( x ) f ( z ) d x d z \geq 0 , ∀ f ∈ {L}_{2} ( x ) \qquad ( 1 )$$

which is referred to as Mercer conditions;

the formula (1) means that k(x, z) is a kernel function, namely,
k(x, z)=(φ(x)·φ(z)), x, z∈X, wherein φ is a mapping from X to a Hilbert space H, φ: |→φ(x)∈H, and (•) is the L₂ inner product of the Hilbert space.
   It is proved below that the constructed function k(x, z)=log₂^{(x}^{^{T}}^{z+1)} can be regarded as a kernel function, and the Mercer conditions are met;
1) let k₁(x, z)=x^{T}z, then the new kernel function can e rewritten as

k(x,z)=log₂^{(x}^{^{T}}^{z+1)}=log₂^{(k}^{₁}^{(x,v)+1)} (2)
2) it is clear that k₁(x, z)=x^{T}z is a linear kernel function, wherein X is a compact set on Rⁿ, k₁(x, z) is a continuous real-valued symmetric function on X×X, and because the element values of the document vectors x and z all are non-negative, k₁(x, z) is non-negative;
3) when the two patent documents DX and DZ are identical, k₁(x, z)=x^{T}z=1, at which time it is necessary that k(x, z)=log₂^{(k}^{₁}^{(x, z)+1)}=log₂²=1; when the two patent documents DX and DZ are totally different, k₁(x, z)=0, at which time it is necessary that k(x, z)=log₂^{(k}^{₁}^{(x, z)+1)}=log₂¹=0;

to sum up, when X is a compact set on Rⁿ, k(x, z)=log₂^{(x}^{^{T}}^{z+1)} is a continuous real-valued symmetric function on X×X and is non-negative;

then it can be concluded from Mercer's Theorem that

$${\int \int }_{X \times X} k ( x , z ) f ( x ) f ( z ) d x d z \geq 0 , ∀ f ∈ {L}_{2} .$$

As such, the constructed k(x, z) can be regarded as a kernel function, namely, k(x, z)=(φ(x)·φ(z)), x, z∈X.

The step 1 specifically comprises:

step (1), bag-of-words (BoW) representation: the entire set of all patent documents to be compared is designated a corpus, the set of content words present in the corpus is designated a dictionary; the two patent documents to be compared DX and DZ are regarded as two bags-of-words respectively;

φ:DZ→zz=φ₁(Z)=(tƒ(t₁,z),t₂,z), . . . ,tƒ(t_{N},z))∈R^{N},

φ:DX→xx=φ₁(X)=(tƒ(t₁,x),tƒ(t₂,x), . . . , tƒ(t_{N},x))∈R^{N},

Φ is BoW mapping, N is the number of words in a dictionary made up of content words in all patent documents to be compared; tᵢ is a content word in the dictionary; ƒ(tᵢ, z) indicates the frequency of the content word tᵢ in the patent document DZ, ƒ(tᵢ, x) indicates the frequency of the content word tᵢ in the patent document DX; i=1, 2, . . . , N;

step (2), semantic representation: since semantic information of the words is not considered in the BoW representation, a semantic kernel is constructed on the basis of the BoW representation; different words are of different importance on a topic, the importance of information carried by a word is quantified with the frequency of the word in a document, i.e. inverse document frequency (IDF) rule, specifically represented by:

$$w ( t ) = ln ( \frac{l}{df ( t )} ) \qquad ( 3 )$$

wherein l is the number of patent documents in the corpus, dƒ(t) is the number of patent documents containing a content word t, and w(t) is an absolute scale as a measure of a weight of the content word t, defined by the IDF;

The semantic vectors of the patent documents to be compared are represented as:

z₀=(ω(t₁)tƒ(t₁,z),ω(t₂,z), . . . , ω(t_{N})tƒ(t_{N},z))∈R^{N}

x₀=(ω(t₁)tƒ(t₁,x),ω(t₂)tƒ(t₂,x), . . . ,tƒω(t_{N})(t_{N},x))∈R^{N}

And then, vectors z₀ and x₀ are normalized to obtain the vectors x and z, respectively.

The present invention has the following advantageous effects. On the one hand, the new kernel function Luke kernel constructed by the present invention is applied in calculation of the similarity of the patent documents, further improving the precision and recall in calculating the similarity of the patent documents. On the other hand, according to the present invention, the patent documents are divided into five elements with the consideration of the role of IPC in calculating the similarity, and the similarities between the respective elements of the two patent documents to be compared are calculated and then a weighted summation is performed to obtain an overall similarity between the two patent documents, improving the precision and recall in calculating the similarity while reducing the calculation costs and improving the calculation efficiency.

This invention was made with support under the projects:
[1] National Natural Science Foundation of China for Distinguished Young Scholars, No. 71403107, “Research On Element Combinatorial Topology And Vector Space Semantic Representation And Calculation Of The Similarity Of Patent Documents”;
[2] Postdoctoral Science Foundation of China for No. 7 Special Fund, No. 2014T70491, “Research On Construction Of Kernel Function And Calculation Of The Similarity Of Patent Documents For Integrated Positions And Semantics”, 2014.7-2016.6;
The Humanities and Social Sciences Foundation of the Ministry, No. 13YJC870026, “Research On Retrieval Of Similar Patent Documents Based On New Kernel Function”.

### BRIEF DESCRIPTION OF THE DRAWINGS

FIG. 1 is a flowchart of a method of the present invention.

### DETAILED DESCRIPTION OF THE INVENTION

The technical solution of the present invention is further described in detail below with reference to the accompanying drawings.

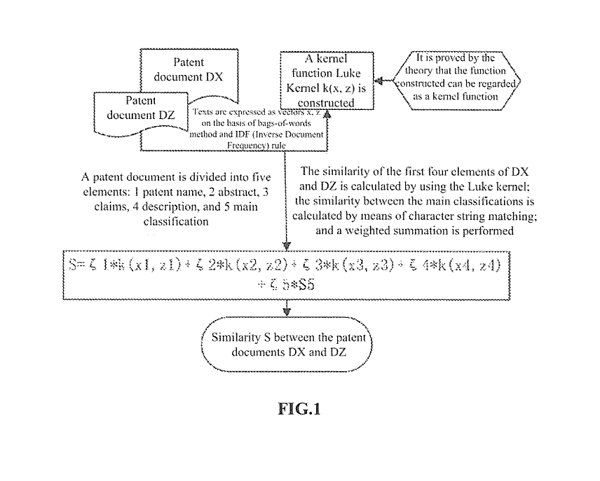

FIG. 1 shows the concepts of the present invention. For convenience of description, the new kernel function k(x, z)=log₂^{(x}^{^{T}}^{z+1)} of the present invention is simply referred to as Luke kernel.

Step 1, the four elements including patent title, abstract, claims, and description of the patent documents are represented as respective vectors x₁, x₂, x₃, x₄, and z₁, z₂, z₃, z₄ using the BoW method and the IDF rule;

Step 2, the similarity of texts corresponding to the elements including patent title, abstract, claims, and description is calculated by using the constructed new kernel function Luke kernel k(x, z)=log₂^{(x}^{^{T}}^{z+1)}; Sⱼ=k(xⱼ, zⱼ)=log₂^{(x}^{ⱼ}^{^{T}}^{Z}^{ⱼ}⁺¹⁾, wherein j=1, 2, 3, 4.

Step 3, the similarity S₅ between the main classifications of the different patent documents is calculated by character string matching, specifically by comparing the main classifications for section, class, subclass, main group, subgroup from front to back. If the main classifications of the two patents are identical, namely, section to subgroup numbers are the same, then S₅=1; if subgroup numbers are different but main group numbers are the same, then S₅=0.75; if main group numbers are different but subclass numbers are the same, then S₅=0.5; if subclass numbers are different but class numbers are the same, then S₅=0.25; if class numbers are different but section numbers are the same, then S₅=0.1; and if all numbers are different, then S₅=0.

Step 4, an overall similarity between the two patent documents is calculated:

$$S = {\sum }^{4} {log}_{2}^{( {x}_{j}^{T} {Z}_{j} + 1 )} + {S}_{5} .$$

The evaluation indexes used in the experiments are Precision, Recall, and an integrated evaluation index F, respectively.

Specific algorithms of the evaluation indexes are:

$$\begin{matrix}Precision = \frac{true positive}{true positive + flase positive} & ( 4 ) \\ Recall = \frac{true positive}{true positive + flase negative} & ( 5 ) \\ {F}_{β} - measure = \frac{( 1 + {β}^{2} ) * precision * recall}{{β}^{2} precision + recall} & ( 6 )\end{matrix}$$

The recall and precision in calculating the similarity of the patent documents are considered to be equally important, and an index F1 is obtained by taking the parameter β in the integrated evaluation index as 1 in the present embodiment.

2000 US patents in the DEWENT patent database are taken in the experimental data, the number of patent documents in the corpus l=2000, and the ratio of training/testing is 3:1. The used software is MATLAB7.0. The Lemur toolkit developed by the information retrieval & language modeling group of Carnegie Mellon University is selected as a toolkit for information retrieval. The Lemur toolkit supports indexing about large-scale databases, and constructing simple language models for documents, questions, or a subset of documents. In addition to these, it also supports conventional retrieval models, for example, vector space model VSM. A linear learning machine used in the experiments is LibSVM.

In the existing studies, the S-Wang kernel in the patent No. ZL201210105942.7 titled “Method For Detecting Similarity Of Documents Based On Kernel Function” has better precision and recall in calculating the similarity between the texts compared to other existing kernel functions. On the basis of this, the present embodiment has compared the effect of the Luke kernel, the S-Wang kernel function, and the linear kernel in detecting the similarity of the patent documents, to obtain the performance of various kernel functions in calculating the similarity. The experiments also have compared the situation wherein the patent documents are regarded as a whole, the situation wherein the similarities between the first four elements including patent names, abstract, claims, and description are calculated respectively and a weighted summation is performed, and the situation the similarities between the five elements with the consideration of main classifications are calculated respectively and a weighted summation is performed. The experimental results are shown in Table 1, Table 2, and Table 3, respectively. In the tables, P indicates scores of precision for calculation of the similarity, R indicates scores of recall for calculation of the similarity, and F₁ is scores of the integrated evaluation index.

TABLE 1
Direct calculation of the similarity using the kernel functions with
the patent documents as a whole

| | linear | S_wang | |
|---|---|---|---|
| | kernel | kernel | Luke kernel |
| P | 0.21 | 0.36 | 0.43 |
| R | 0.87 | 0.91 | 0.93 |
| F₁ | 0.34 | 0.52 | 0.59 |

TABLE 2
Calculation of the similarities between only the first four elements
without considering IPC and then weighted summation

| | linear | S_wang | |
|---|---|---|---|
| | kernel | kernel | Luke kernel |
| P | 0.25 | 0.39 | 0.50 |
| R | 0.88 | 0.93 | 0.95 |
| F1 | 0.39 | 0.55 | 0.66 |

TABLE 3
Calculation of the similarities between the five elements and then
weighted summation

| | linear | S_wang | |
|---|---|---|---|
| | kernel | kernel | Luke kernel |
| P | 0.29 | 0.41 | 0.58 |
| R | 0.90 | 0.94 | 0.96 |
| F₁ | 0.44 | 0.57 | 0.72 |

*In the present embodiment, the weight coefficients for the similarity of the five elements including patent title, abstract, claims, description, and main classification are taken as ζ₁=0.1, ζ₂=0.1, ζ₃=0.25, ζ₄=0.25, ζ₅=0.3 respectively.

It can be seen from Table 1, Table 2, and Table 3, the Luke kernel of the present invention has good performance in calculating the similarity. It can be seen by comparing Table 2 and Table 3 that the technical solution of the present invention, wherein the main classifications are considered to divide the patent documents into the five elements and the similarities between the respective elements are calculated and then a weighted summation is performed to obtain the similarity of the patent documents, further improves the performance in calculating the similarity.

The experimental results indicate that, the technical solution for calculating the similarity of the patent documents adapted by the present invention improves the precision and recall in calculating the similarity of the patent documents.

What is claimed is:

1. A method for detecting the similarity of patent documents based on a new kernel function Luke kernel, comprising:
step 1, representing the texts of two patent documents to be compared DX and DZ as vectors x and z respectively;
step 2, structural representation of the patent documents, by dividing the patent documents into five elements including patent title, abstract, claims, description, and main classification, i.e. IPC main classification, and representing the first four elements of the two patent documents to be compared DX and DZ as vectors x₁, x₂, x₃, x₄, and z₁, z₂, z₃, z₄ according to the step 1 respectively;
step 3, constructing a new kernel function k(x, z) suitable for calculation of the similarity of the patent documents, and it is proved by the theory whether the function k(x, z) can be regarded as a kernel function for calculation of the similarity;
step 4, calculating the similarity Sⱼ between the respective first four elements of the two patent documents to be compared DX and DZ by using the kernel function k(x, z): Sⱼ=k(xⱼ, zⱼ), wherein j=1, 2, 3, 4;
then calculating the similarity S₅ between the main classifications of the two patent documents to be compared DX and DZ directly by means of character string matching, specifically by comparing the main classifications for section, class, subclass, main group, and subgroup from front to back, wherein if the main classifications of the two patents are identical, namely, section to subgroup numbers are the same, then S₅=1; if subgroup numbers are different but main group numbers are the same, then S₅=0.75; if main group numbers are different but subclass numbers are the same, then S₅=0.5; if subclass numbers are different but class numbers are the same, then S₅=0.25; if class numbers are different but section numbers are the same, then S₅=0.1; and
if all numbers are different, then S₅=0;
and finally performing a weighted summation to obtain the similarity S of the two patent documents to be compared DX and DZ:
$$S = {\sum }_{j = 1}^{5} {ζ}_{j} {S}_{j} ;$$
wherein
$${\sum }_{j = 1}^{5} {ζ}_{j} = 1 , 0 \leq {ζ}_{j} \leq 1 , j = 1 , 2 , … , 5.$$

2. The method for detecting the similarity of patent documents based on a new kernel function Luke kernel according to claim 1, wherein the new kernel function k(x, z) is in the form of k(x, z)=log₂^{(x}^{^{T}}^{z+1)}.

3. The method for detecting the similarity of patent documents based on a new kernel function Luke kernel according to claim 2, wherein the theoretical demonstration that the new kernel function can be regarded as a kernel function is as follows:
let X is a compact set on Rⁿ, and k(x, z) is a continuous real-valued symmetric function on X×X, then:
$${\int \int }_{X \times X} k ( x , z ) f ( x ) f ( z ) d x d z \geq 0 , ∀ f ∈ {L}_{2} ( x ) \qquad ( 1 )$$
which is referred to as Mercer conditions;
the formula (1) means that k(x, z) is a kernel function, namely, k(x, z)=(φ(x)·φ(z)), x, z∈X wherein φ is a mapping from X to a Hilbert space H, φ: |→φ(x)∈H, and (•) is the L₂ inner product of the Hilbert space; it is proved below that the constructed function k(x, z)=log₂^{(x}^{^{T}}^{z+1)} can be regarded as a kernel function, and the Mercer conditions are met;
1) let k₁(x, z)=x^{T}z, then the new kernel function can be rewritten as
k(x,z)=log₂^{(x}^{^{T}}^{z+1)}=log₂^{(k}^{₁}^{(x,v)+1)} (2)
2) it is clear that k₁(x, z)=x^{T}z is a linear kernel function, wherein when X is a compact set on Rⁿ, k₁(x, z) is a continuous real-valued symmetric function on X×X, and because the element values of the document vectors x and z all are non-negative, k₁(x, z) is non-negative;
3) when the two patent documents DX and DZ are identical, k₁(x, z)=x^{T}z=1, at which time it is necessary that k(x, z)=log₂^{(k}^{₁}^{(x, z)+1)}=log₂²=1; when the two patent documents DX and DZ are totally different, k₁(x, z)=0, at which time it is necessary that k(x, z)=log₂^{(k}^{₁}^{(x, z)+1)}=log₂¹=0;
to sum up, when X is a compact set on Rⁿ, k(x, z)=log₂^{(x}^{^{T}}^{z+1)} is a continuous real-valued symmetric function on X×X and is non-negative; then it can be concluded from Mercer's Theorem that
$${\int \int }_{X \times X} k ( x , z ) f ( x ) f ( z ) d x d z \geq 0 , ∀ f ∈ {L}_{2} ;$$
as such, the constructed k(x, z) can be regarded as a kernel function, namely, k(x, z)=(φ(x)·φ(z)), x, z∈X.

4. The method for detecting the similarity of patent documents based on a new kernel function Luke kernel according to claim 1, wherein the step 1 specifically comprises:
step (1), bag-of-words (BoW) representation: the entire set of all patent documents to be compared is designated a corpus, the set of content words present in the corpus is designated a dictionary; the two patent documents to be compared DX and DZ are regarded as two bags-of-words respectively,
φ:DZ→zz=φ₁(Z)=(tƒ(t₁z),tƒ(t₂,z), . . . , tƒ(t_{N},z))∈R^{N},
φ:DX→xx=φ₁(X)=(tƒ(t₁,x),tƒ(t₂,x), . . . , tƒ(t_{N},x))∈R^{N},
Φ is BoW mapping, N is the number of content words in a dictionary made up of content words in all patent documents to be compared; tᵢ is a content word in the dictionary; ƒ(tᵢ, z) indicates the frequency of the content word tᵢ in the patent document DZ, ƒ(tᵢ, x) indicates the frequency of the content word tᵢ in the patent document DX; i=1, 2, . . . , N;
step (2), semantic representation: since semantic information of the words is not considered in the BoW representation, a semantic kernel is constructed on the basis of the BoW representation; different words are of different importance on a topic, the importance of information carried by a word is quantified with the frequency of the word in a document, i.e. inverse document frequency (IDF) rule, specifically represented by:
$$w ( t ) = ln ( \frac{l}{df ( t )} ) \qquad ( 3 )$$
wherein l is the number of patent documents in the corpus, dƒ(t) is the number of patent documents containing a content word t, and w(t) is an absolute scale as a measure of a weight of the content word t, defined by the IDF;
further, the semantic vectors of the patent documents to be compared DX and DZ are represented as:
z₀=(ω(t₁)tƒ(t₁,z),ω(t₂)tƒ(t₂,z), . . . , ω(t_{N})tƒ(t_{N},z))∈R^{N}
x₀=(ω(t₁)tƒ(t₁,x),ω(t₂)tƒ(t₂,x), . . . , tƒω(t_{N})(t_{N},x))∈R^{N}
and then, vectors z₀ and x₀ are normalized to obtain the vectors x and z, respectively.
